(19) United States
(12) Patent Application Publication
(10) Pub. No.: US 2026/0046770 A1
(43) Pub. Date: Feb. 12, 2026

(54) UE LP-WUS AND PDCCH MONITORING WITH C-DRX CONFIGURATION

(71) Applicant: APPLE INC., Cupertino, CA (US)

(72) Inventors: Dan Wu, Beijing (CN); Dawei Zhang, Saratoga, CA (US); Wei Zeng, Saratoga, CA (US); Sigen Ye, San Diego, CA (US); Hong He, San Jose, CA (US); Fangli Xu, Beijing (CN)

(21) Appl. No.: 19/254,342

(22) Filed: Jun. 30, 2025

Related U.S. Application Data
(60) Provisional application No. 63/681,014, filed on Aug. 8, 2024.

(51) Int. Cl. H04W 52/02

(52) U.S. Cl. CPC H04W 52/0235; H04W 52/0212

(57) ABSTRACT

Embodiments herein methods systems and apparatuses for Low Power Wake-Up Signal (LP-WUS) monitoring with Connected-mode Discontinuous Reception (C-DRX) configuration. In some embodiments, a UE may receive, from a network node, activation signaling indicating LP-WUS monitoring. The UE may monitor LP-WUS occasions based on the activation signal. In response to detecting an LP-WUS indicating Physical Downlink Control Channel (PDCCH) monitoring in one of the LP-WUS occasions, the UE may control a timer for PDCCH monitoring.

### TECHNICAL FIELD

This application relates generally to wireless communication systems, including use of Low Power Wake-Up Signal (LP-WUS) when a UE is configured with Connected-mode Discontinuous Reception (C-DRX).

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems'standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example table for Evaluation period T_{Evaluate_out_CSI-RS} and T_{Evaluate_in_CSI-RS} for FR1 in accordance with some embodiments.

FIG. 2 illustrates an example timeline for LP-WUS monitoring based on RRC configuration in accordance with some embodiments.

FIG. 3 illustrates an example timeline for LP-WUS monitoring outside at least legacy C-DRX active time in accordance with some embodiments.

FIG. 4 illustrates an example timeline for LP-WUS monitoring outside at least legacy C-DRX active time in accordance with some embodiments.

FIG. 5 illustrates an example timeline for LP-WUS monitoring outside legacy C-DRX active time where PDCCH is not triggered by legacy C-DRX and drx-onDurationTimer when monitoring LP-WUS in accordance with some embodiments.

FIG. 6 illustrates an example timeline for LP-WUS monitoring inside at least legacy C-DRX active time according to an LP-WUS monitoring configuration to trigger PDCCH monitoring in accordance with some embodiments.

FIG. 7 illustrates example of options of how a UE may determine when to start monitoring LP-WUS during the C-DRX active time in accordance with some embodiments.

FIG. 8A illustrates a first example embodiment for drx-onDurationTimer (Timer set-1) behavior in accordance with some embodiments.

FIG. 8B illustrates a second example embodiment for drx-onDurationTimer (Timer set-1) behavior in accordance with some embodiments.

FIG. 9 illustrates three example signaling timelines that show possible UE behaviors upon detection of LP-WUS indicating PDCCH monitoring in embodiments where the Drx-onDurationTimer continues running when LP-WUS monitoring is activated in accordance with some embodiments.

FIG. 10 illustrates two example signaling timelines that show possible UE behaviors upon detection of LP-WUS indicating PDCCH monitoring in embodiments where the drx-onDurationTimer stops running when LP-WUS monitoring is activated in accordance with some embodiments.

FIG. 11 illustrates a method performed by a UE, according to embodiments herein.

FIG. 12 illustrates a method performed by a network node, according to embodiments herein.

FIG. 13 illustrates an example architecture of a wireless communication system, according to embodiments disclosed herein.

FIG. 14 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

One of the objectives of a wireless communication system is to reduce power consumption while maintaining quality of service. Low Power Wake-Up Signal (LP-WUS) is a mechanism defined within the 3GPP standards aimed at reducing the power consumption of User Equipment (UE) in connected and idle modes. LP-WUS allows devices to remain in a low-power state while waiting for a wake-up signal, significantly extending battery life, especially for devices that do not need to be continuously active. The wake-up signal is designed to be detected by the UE with minimal energy expenditure. When a wake-up signal is received, the device transitions from a low-power state to an active state to receive data or perform tasks.

LP-WUS supports various operational modes, including idle and connected modes, to ensure that the device can manage its power consumption effectively across different states of activity. One aspect of Low-power wake-up signal and receiver for NR includes procedures to allow UE on-demand Synchronization Signal Block (SSB) Secondary Cell (SCell) operation for CONNECTED mode UEs. For CONNECTED mode, certain procedures can allow the UE Measurement Report Physical Downlink Control Channel (MR PDCCH) monitoring triggered by LP-WUS including activation and deactivation procedure of LP-WUS monitoring (RAN2, RAN1) For RRC CONNECTED mode, it may be beneficial for further study LP-WUS procedures to trigger PDCCH monitoring. In a first case, PDCCH monitoring can be triggered by LP-WUS with Connected Mode Discontinuous Reception (C-DRX) configuration. In some embodiments (option 1-1), LP-WUS monitoring may be according to the LP-WUS with C-DRX configuration before drx-onDurationTimer to trigger the starting of the drx-onDurationTimer. This option may replace Downlink Control Protocol (DCP) functionality.

In some embodiments (option 1-2), LP-WUS monitoring outside at least legacy C-DRX active time may be according to the LP-WUS monitoring configuration to trigger PDCCH monitoring. PDCCH monitoring may be performed possibly irrespective of drx-onDurationTimer. For example, in some embodiments (Option 1-2-1) PDCCH monitoring may be additionally triggered based on legacy C-DRX cycle and drx-onDurationTimer when monitoring LP-WUS. If this were adopted, Option 1-2-1 may be configured together with Option 1-1 to achieve power saving gain compared to legacy C-DRX. In some embodiments (Option 1-2-2), PDCCH monitoring may not be triggered by legacy C-DRX cycle and drx-onDurationTimer when monitoring LP-WUS.

In some embodiments (Option 1-3), LP-WUS monitoring may be inside at least legacy C-DRX active time according to the LP-WUS monitoring configuration to trigger PDCCH monitoring. In some embodiments, PDCCH monitoring may be triggered by LP-WUS without C-DRX configuration. LP-WUS may be monitored at any time according to the LP-WUS monitoring configuration. In some embodiments, some or all of the options described above may be combined.

Some standards may not discuss C-DRX related timers other than drx-onDurationTimer. Note that the above does, not preclude to support fallback mechanism to trigger PDCCH monitoring, if any. Embodiments herein may provide LP-WUS configuration processes, activation of timers, and behaviors of the timers.

Measurement behaviors when C-DRX is configured may include the following. For legacy Channel State Information (CSI) measurement and reporting may be based on the Active Time. Whether CSI is measured and reported in the drx-onDurationTime outside Active Time is based on configuration. There may be a new definition of Active impacts the CSI measurement and reporting. Legacy L3 mobility measurement may be based on the Active Time and the drx-onDurationTime also outside the Active Time. Legacy Reference Signal Received Power (RSRP) Radio Link Monitoring (RLM) and Beam Failure Detection (BFD) measurement may be based on the C-DRX cycle.

For CSI measurement and report, if the UE is configured with DRX, the most recent CSI measurement occasion occurs in DRX active time for CSI may be reported. If UE is configured with DRX and DCI format 2_6, Periodic CSI may be further controlled by ps-TransmitPeriodicL1-RSRP and ps-TransmitOtherPeriodicCSI. The most recent CSI occasion in DRX active or during the time duration indicated by drx-onDurationtimer in DRX-Config for CSI may be reported. Further, in some embodiments, the UE may not report CSI on Physical Uplink Control Channel (PUCCH) (including periodic and semi-persistent CSI) and emi-persistent CSI on Physical Uplink Shared Channel (PUSCH) outside Active Time. If drx-onDurationTimer associated with the current DRX cycle is not started, UE may not report semi-persistent CSI on PUCCH and on PUSCH. Periodic CSI may be further controlled by ‘ps-TransmitPeriodicL1-RSRP’ and ‘ps-TransmitOtherPeriodicCSI’. In some embodiments, the UE does not transmit Periodic Sounding Reference Signal (SRS) and semi-persistent SRS outside C-DRX Active time.

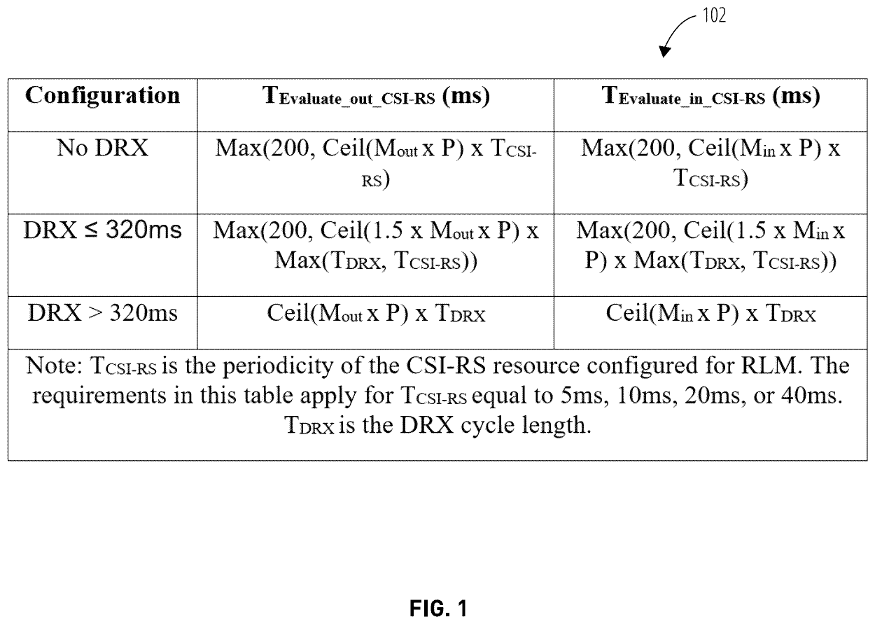

FIG. 1 illustrates an example table 102 for Evaluation period T_{Evaluate_out_CSI-RS} and T_{Evaluate_in_CSI-RS} for FR1. For L3 mobility, a UE may not expect CSI-RS resource available outside Active Time when C-DRX cycle is larger than 80 ms. When DCI 2_6 is configured, the UE may also not expect CSI-RS resource available during the drx-onDurationTimer also outside C-DRX Active Time when C-DRX cycle is larger than 80 ms. Otherwise, the UE may assume CSI-RS are available based on configuration.

For RLM measurement, the UE may assess once per indication period of the radio link quality. An indication period may be determined as the maximum between the shortest periodicity of RLM resources and DRX period. For BFD measurement, the UE may indicate according to a periodicity determined according to the larger of DRX cycle and the CSI-RS resource periodicity.

Some embodiments herein describe UE behaviors for LP-WUS. For each option/option combination, the UE behaviors of LP-WUS monitoring and PDCCH monitoring may be thought of in the following three steps Step 1: Activation of LP-WUS monitoring. Step 2: UE behavior when LP-WUS is activated/configured. Step 3: UE behavior upon detection of LP-WUS indicating PDCCH monitoring. The CSI measurement and reporting may be based on the Active Time. A new definition of Active impacts the CSI measurement and reporting may be described. The L3 mobility measurement may be based on the Active Time and the drx-onDurationTime also outside the Active Time. The RLM and BFD measurement may be based on the C-DRX cycle.

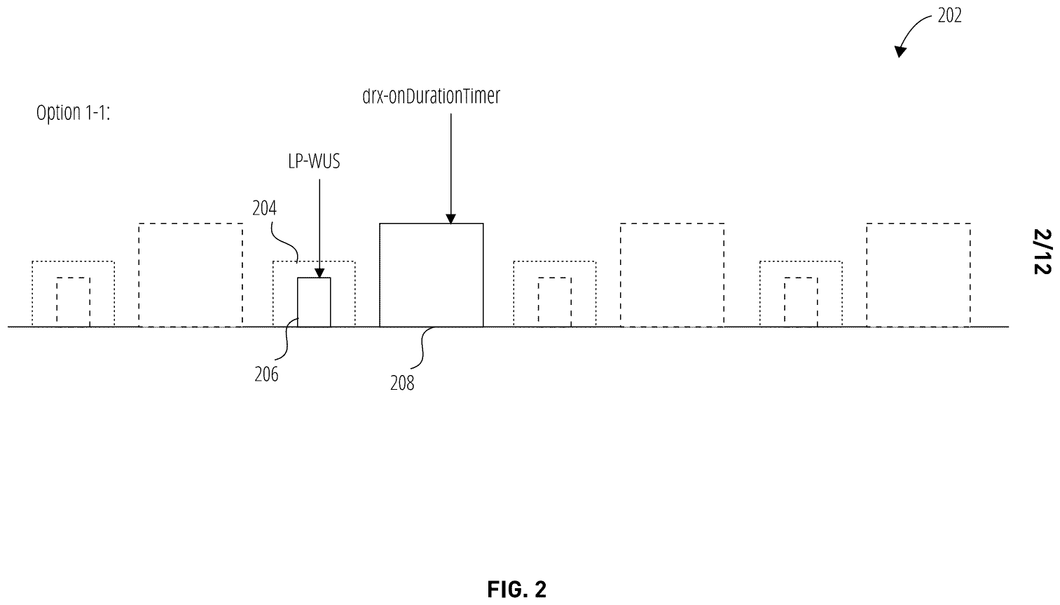

FIG. 2 illustrates an example timeline 202 for LP-WUS monitoring based on RRC configuration in accordance with some embodiments. The timeline 202 illustrates an embodiment (option 1-1) where detection of LP-WUS 206 triggers drx-onDurationTimer. A network node may provide a UE with an RRC configuration. The RRC configuration may provide a monitoring window during which the UE may monitor for the LP-WUS.

The UE may start to monitor for LP-WUS 206 during the monitoring windows (e.g., window 204) based on the RRC configuration from the network node. In other words, receiving the RRC configuration may activate the LP-WUS monitoring. As shown, the UE may monitor LP-WUS occasions in a window before the start of drx-onDurationTimer. Upon detection of LP-WUS 206 indicating PDCCH monitoring, the UE may start the drx-onDurationTimer 208 according to the configuration.

The drx-onDurationTimer is a timer used to control when the UE should actively monitor the PDCCH for potential downlink transmissions. During the drx-onDurationTimer the UE enters an active state where it monitors the PDCCH for potential downlink data. If no data is scheduled for the UE during this period, the onDurationTimer expires, and the UE transitions to a low-power sleep state. If data is scheduled or other wake-up events occur (e.g., paging, random access response), the UE may wake up to receive the data.

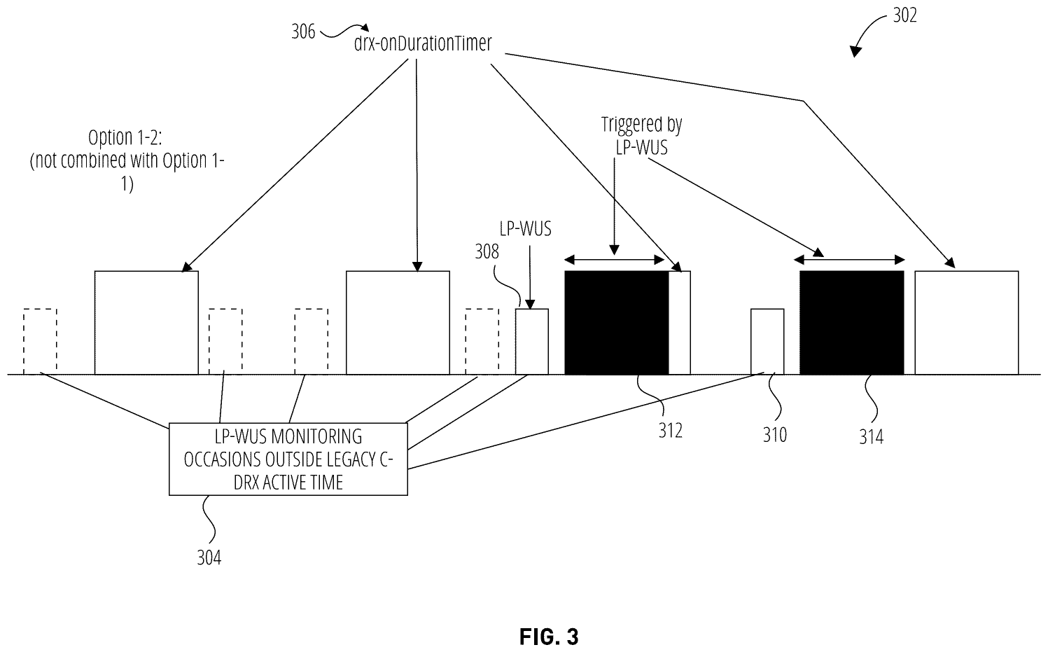

FIG. 3 illustrates an example timeline 302 for LP-WUS monitoring outside at least legacy C-DRX active time in accordance with some embodiments. The timeline 302 illustrates an example embodiment that employs option 1-2. In this embodiment, LP-WUS monitoring outside at least legacy C-DRX active time may be according to the LP-WUS monitoring configuration to trigger PDCCH monitoring.

The UE may receive an RRC configuration from a network node that includes a configuration for LP-WUS monitoring. The UE may monitor for LP-WUS during LP-WUS monitoring occasions 304. Upon detection of LP-WUS (e.g., LP-WUS 308 and LP-WUS 310) indicating PDCCH monitoring, a drx-InactivityTimer (e.g., drx-InactivityTimer 312 and drx-InactivityTimer 314) may be started according to the configuration. During the drx-InactivityTimer, the UE may monitor PDCCH. As shown, PDCCH monitoring may be performed possibly irrespective of drx-onDurationTimer 306.

The PDCCH monitoring may also be performed during the drx-onDurationTimer 306. As shown in the illustrated embodiment, the drx-onDurationTimer 306 may be based on a legacy C-DRX cycle. Accordingly, the UE may receive a configuration from a network node for C-DRX and monitor PDCCH during C-DRX active time and outside of C-DRX active time when LP-WUS is detected.

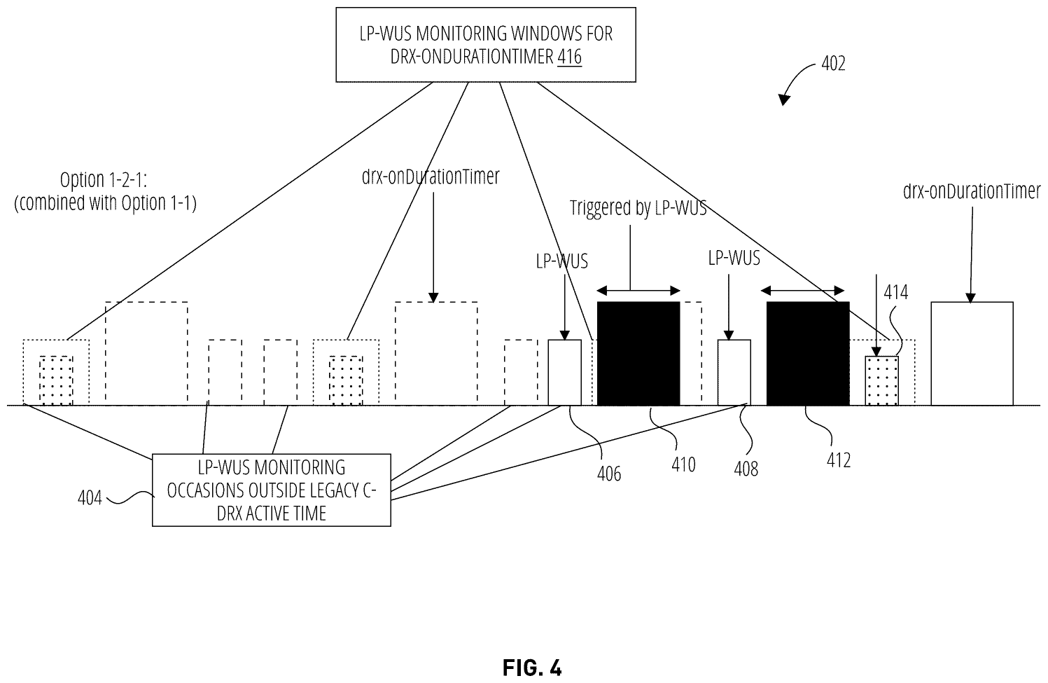

FIG. 4 illustrates an example timeline 402 for LP-WUS monitoring outside at least legacy C-DRX active time in accordance with some embodiments. The illustrated embodiment may be referred to as option 1-2-1. In this embodiment, LP-WUS monitoring outside at least legacy C-DRX active time may be according to the LP-WUS monitoring configuration to trigger PDCCH monitoring.

The UE may receive an RRC configuration from a network node that includes a configuration for LP-WUS monitoring. The UE may monitor for LP-WUS during LP-WUS monitoring occasions 404. Upon detection of LP-WUS (e.g., LP-WUS 406 and LP-WUS 408) indicating PDCCH monitoring, a new timer or drx-InactivityTimer (e.g., new timer 410 and new timer 412) may be started according to the configuration. During the new timer/drx-InactivityTimer, the UE may monitor PDCCH outside of drx-onDurationTimer. As shown, PDCCH monitoring may be performed possibly irrespective of drx-onDurationTimer. Further, in the illustrated embodiment, PDCCH monitoring may be additionally triggered based on legacy C-DRX cycle and drx-onDuration timer.

The UE may start monitoring LP-WUS based on RRC configuration from a network node. The following options can be considered for the LP-WUS configuration and triggering of corresponding timers.

In some embodiments, the network may provide the UE with two LP-WUS configurations, one is to control the legacy drx-onDurationTimer (as in Option 1-1), the other is to control a new timer or drx-InactivityTimer. For instance, LP-WUS 408 may be detected and trigger new timer 412, during which the UE may monitor PDCCH.

Additionally, the UE may monitor LP-WUS monitoring windows for drx-onDurationTimer 416 as configured in the LP-WUS configuration to control the legacy drx-onDurationTimer. When LP-WUS (e.g., LP-WUS 414) is detected in the LP-WUS monitoring windows for drx-onDurationTimer 416 the UE may start the drx-onDurationTimer and monitor PDCCH during the drx-onDurationTimer.

In some embodiments, the network node may provide the UE with one LP-WUS configuration, plus a window configuration before drx-onDurationTimer. The LP-WUS monitored inside the configured window (e.g., LP-WUS monitoring windows for drx-onDurationTimer 416) may trigger the drx-onDurationTimer, and the LP-WUS monitored outside the configured window triggers the new timer/legacy drx-InactivityTimer. For example, when the UE detects LP-WUS 414 inside of LP-WUS monitoring windows for drx-onDurationTimer 416 the UE triggers the drx-onDurationTimer, and the UE detects LP-WUS 408 outside of the LP-WUS monitoring windows for drx-onDurationTimer 416 the UE triggers the new timer/legacy drx-InactivityTimer (e.g., new timer 412).

In some embodiments, the network node may provide the UE with one LP-WUS configuration (e.g., a LP-WUS configuration that includes time and frequency) where separated sequence or payload is used to indicate whether the LP-WUS triggers legacy drx-onDurationTimer or the new timer/legacy drx-InactivityTimer. The separate sequence or payload may explicitly indicate whether the LP-WUS triggers the legacy drx-onDurationTimer or the new timer/legacy drx-InactivityTimer.

Based on the LP-WUS configuration, the UE may monitor for LP-WUS. The UE may monitor LP-WUS occasions according to the configuration outside the C-DRX Active Time. The following provides two options for UE monitoring LP-WUS occasions according to the configuration outside the C-DRX Active Time. In a first option, the timer/PDCCH monitoring duration triggered by LP-WUS (e.g., LP-WUS 406 and LP-WUS 408) is included in C-DRX Active Time. For instance, the new timer or drx-InactivityTimer (e.g., new timer 412) may be included in C-DRX Active Time.

Accordingly, for embodiments using this option CSI measurement and reporting may be done during the new timer/drx-InactivityTimer in addition to PDCCH monitoring. In a second option, the timer/PDCCH monitoring duration triggered by LP-WUS (e.g., LP-WUS 406 and LP-WUS 408) is not included in C-DRX Active Time. Accordingly, for embodiments using this option the UE can monitor both LP-WUS and PDCCH during this period. In some embodiments the UE may not perform the CSI measurement and reporting during this period when using the second option.

Upon detection of LP-WUS indicating PDCCH monitoring (e.g., LP-WUS 406 and LP-WUS 408), the following behaviors can be considered. In some embodiments, upon detection of the LP-WUS indicating PDCCH monitoring the UE starts the drx-onDurationTimer. Accordingly, in such embodiments the length of the PDCCH monitoring may be the same as is triggered by the LP-WUS configuration to control the legacy drx-onDurationTimer. In other embodiments, the UE may start a timer that may be the same or different in length than the drx-onDurationTimer. For example, the upon detection of the LP-WUS indicating PDCCH monitoring the UE may start the drx-InactivityTimer. Further, in some embodiments, a new timer may be implemented for this LP-WUS indicating PDCCH monitoring. For example, the upon detection of the LP-WUS indicating PDCCH monitoring the UE may start a new timer (e.g., Ip-triggeredTimer).

In some embodiments, which timer is to be triggered and/or the length of the timer may be configured by the network node. For example, based on the configurations received for LP-WUS configuration, the UE may know which timer to start when it detects the LP-WUS.

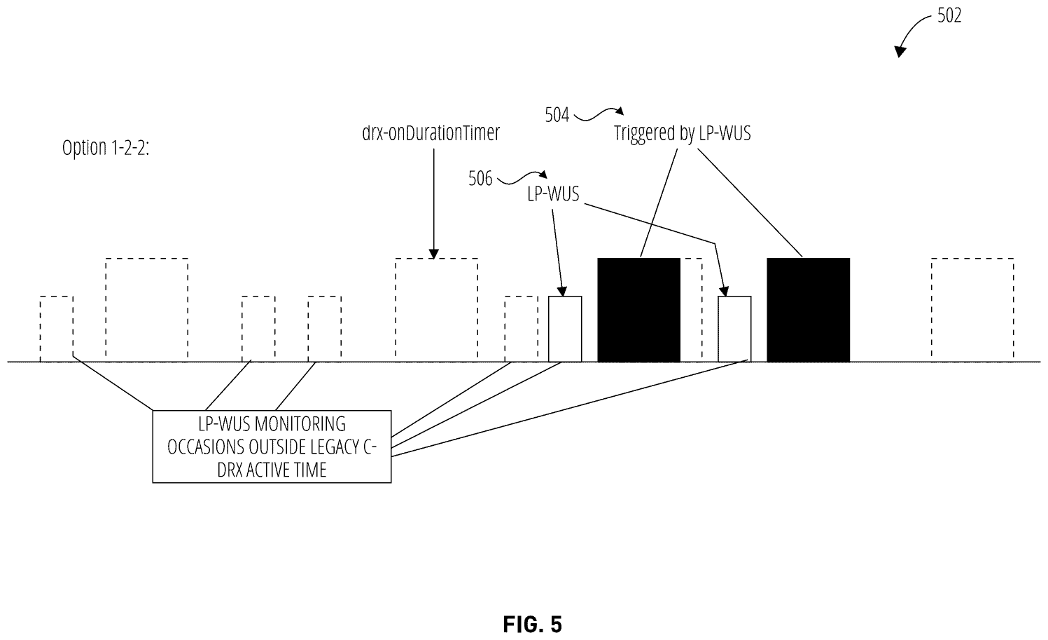

FIG. 5 illustrates an example timeline 502 for LP-WUS monitoring outside legacy C-DRX active time where PDCCH monitoring is not triggered by legacy C-DRX and drx-onDurationTimer when monitoring LP-WUS in accordance with some embodiments. The illustrated embodiment may be referred to as option 1-2-2. In the illustrated embodiment, detection of LP-WUS 506 triggers legacy drx-InactivityTimer or a new timer 504.

The UE may receive an LP-WUS configuration from a network node via RRC. The UE may start monitoring LP-WUS is based on the RRC configuration. One LP-WUS configuration may be enough to configure the UE for LP-WUS monitoring in the illustrated embodiment, and UE may monitor the LP-WUS according to this configuration outside C-DRX Active Time.

Based on the LP-WUS configuration, the UE may monitor for LP-WUS 506. The UE may monitor LP-WUS occasions according to the configuration outside the C-DRX Active Time. The following provides two options for UE monitoring LP-WUS occasions according to the configuration outside the C-DRX Active Time. In a first option, the timer/PDCCH monitoring duration triggered by LP-WUS 506 is included in C-DRX Active Time. For instance, the new timer or drx-InactivityTimer (e.g., new timer 504) may be included in C-DRX Active Time. Accordingly, for embodiments using this option CSI measurement and reporting may be done during the new timer/drx-InactivityTimer in addition to PDCCH monitoring. In a second option, the timer/PDCCH monitoring duration triggered by LP-WUS 506 is not included in C-DRX Active Time. Accordingly, for embodiments using this option the UE can monitor both LP-WUS and PDCCH during this period. In some embodiments the UE may not perform the CSI measurement and reporting during this period when using the second option.

Upon detection of LP-WUS 506 indicating PDCCH monitoring, the following behaviors can be considered. In some embodiments, the UE may start a timer that may be the same or different in length than the drx-onDurationTimer. For example, the upon detection of the LP-WUS indicating PDCCH monitoring the UE may start the drx-InactivityTimer. Further, in some embodiments, a new timer may be implemented for this LP-WUS indicating PDCCH monitoring. For example, the upon detection of the LP-WUS indicating PDCCH monitoring the UE may start a new timer (e.g., Ip-triggeredTimer).

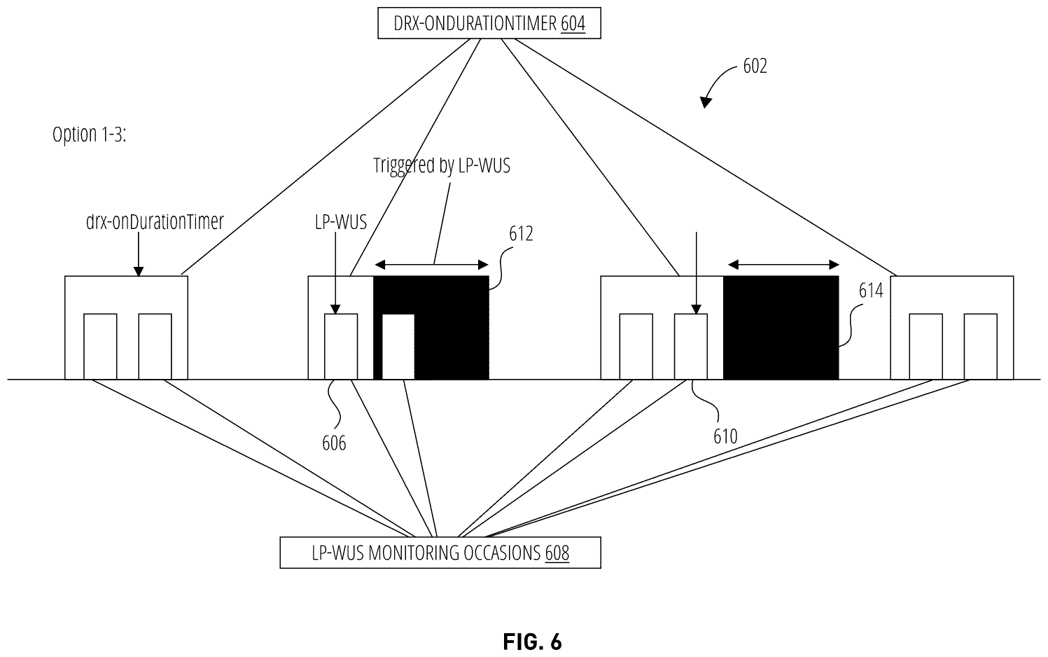

FIG. 6 illustrates an example timeline 602 for LP-WUS monitoring inside at least legacy C-DRX active time according to an LP-WUS monitoring configuration to trigger PDCCH monitoring in accordance with some embodiments. The illustrated embodiment may be referred to as option 1-3. A UE may receive an LP-WUS monitoring configuration from a network node. As shown, the LP-WUS monitoring configuration may cause the UE with LP-WUS monitoring occasions 608 during the drx-onDurationTimer 604. When the UE detects LP-WUS (e.g., LP-WUS 606 and LP-WUS 610) it may trigger a behavior change of the UE. For example, in the illustrated embodiment, the UE begins timer 612 and timer 614 after detecting LP-WUS 606 and LP-WUS 610.

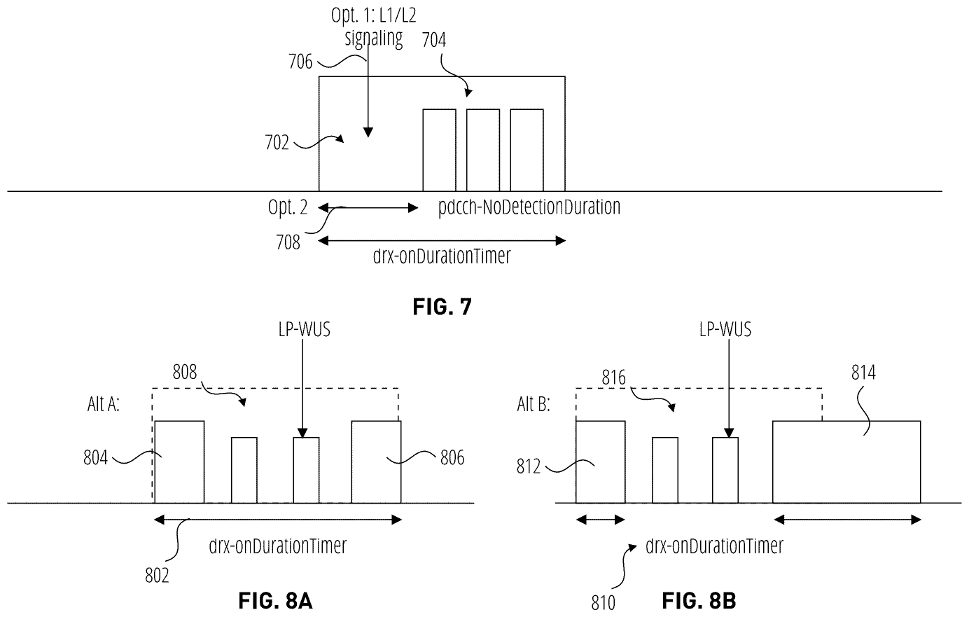

FIGS. 7-9 illustrate additional details of behaviors that may be used when a system implements option 1-3. Embodiments employing option 1-3, may have two options for an initial state when the drx-onDurationTimer starts. A first state option may be that the UE starts with PDCCH monitoring when the drx-onDurationTimer starts. A second state option may be that the UE starts with monitoring LP-WUS when the drx-onDurationTimer starts.

If the UE starts the drx-onDurationTimer with PDCCH monitoring, the UE may determine when to switch to monitoring LP-WUS. FIG. 7 illustrates example of options of how a UE may determine when to start monitoring LP-WUS 704 during the C-DRX active time. As shown, the UE may start the drx-onDurationTimer with PDCCH monitoring. During a first period 702 the UE may perform PDCCH monitoring and not monitoring LP-WUS 704.

In some embodiments, the UE may determine when to start monitoring LP-WUS 704 based on layer 1/layer 2 (L1/L2) signaling, based on a specific duration without PDCCH, or based on a combination of signaling and duration without PDCCH. For example, in some embodiments, L1/L2 signaling 706 may indicate the start of LP-WUS monitoring. A timer/duration can be configured within the L1/L2 signaling, to indicate the duration of the LP-WUS monitoring. In some embodiments, if the UE does not receive PDCCH within a duration, LP-WUS monitoring may be activated. This behavior can be configured by the network node. For example, the duration may be configured through a pdcch-NoDetectDuration 708.

In some embodiments, a combination of L1/L2 signaling 706 and determining that the UE does not receive PDCCH within a duration (pdcch-NoDetectDuration 708) may be used by the UE to determine when to begin (e.g., activate) LP-WUS monitoring. For example, if a pdcch-NoDetectDuration 708 is configured, the UE may activate LP-WUS monitoring when UE does not receive PDCCH within pdcch-NoDetectDuration 708 is used, and in response to the pdcch-NoDetectDuration 708 not being configured L1/L2 signaling 706 may be used to activate LP-WUS monitoring.

When LP-WUS monitoring is activated for option 1-3 (either as the initial state, or based on the signaling or duration without PDCCH), the following behaviors (illustrated in FIG. 8A and FIG. 8B) for legacy timers could be considered. FIG. 8A illustrates a first example embodiment for drx-onDurationTimer 802 (Timer set-1) behavior in accordance with some embodiments. As shown, in some embodiments, the drx-onDurationTimer 802 may continue running, however the UE behavior may be changed. For example, when LP-WUS monitoring 808 is activated, although drx-onDurationTimer is running, UE does not monitor PDCCH. In the illustrated embodiment, the UE begins PDCCH monitoring 804 when drx-onDurationTimer 802 starts, and after a specified duration or because of L1/L2 signaling the UE activates LP-WUS monitoring 808. During LP-WUS monitoring 808 the drx-onDurationTimer 802 continues to run. After LP-WUS is received or at the end of the LP-WUS monitoring time, the UE may return to PDCCH monitoring 806 for the remainder of the drx-onDurationTimer 802.

FIG. 8B illustrates a second example embodiment for drx-onDurationTimer 810 (Timer set-1) behavior in accordance with some embodiments. As shown, in some embodiments, drx-onDurationTimer 810 is stopped during LP-WUS monitoring 816. As shown, the drx-onDurationTimer 810 may run while the UE performs PDCCH monitoring 812, stop during LP-WUS monitoring 816, and then be extended until the timer reaches the total length of the drx-onDurationTimer 810 when PDCCH monitoring 814 resumes after the LP-WUS monitoring 816.

Other legacy timers may also have optional behaviors based on the LP-WUS monitoring during the C-DRX active time. For drx-InactivityTimer, drx-RetransmissionTimerDL, drx-RetransmissionTimerUL, etc., and transmission (Timer set-2), in some embodiments the timers continue running during LP-WUS monitoring, and the UE stops monitoring PDCCH. In some embodiments, for drx-InactivityTimer, drx-RetransmissionTimerDL, drx-RetransmissionTimerUL, etc. and transmission (Timer set-2), the timers are terminated (e.g., not resuming). For example, when LP-WUS monitoring is activated, the timers may be ended, and new timers may begin after the LP-WUS monitoring has ended.

For ra-ContentionResolutionTimer, and random access related behaviors (Timer set-3), in some embodiments the timers continue running when LP-WUS monitoring is activated, and UE stops monitoring the corresponding PDCCH. In some embodiments, these timers continue running when LP-WUS is activated, and the UE keeps monitoring the corresponding PDCCH. In some embodiments, these timers are terminated (not resuming) when LP-WUS is activated. For example, when LP-WUS monitoring is activated, the timers may be ended, and new timers may begin after the LP-WUS monitoring has ended.

In some embodiments, the above options and embodiments for behaviors of legacy timers may be combined. For example, in some embodiments, a UE may continue running drx-onDurationTimer and Timer set-2 while stopping monitoring the corresponding PDCCH during LP-WUS monitoring, and may continue running Timer set-3 and continue monitoring the corresponding PDCCH during LP-WUS monitoring.

This may avoid impact to Medium Access Control (MAC) and maintain Random Access Channel (RACH) performance. In some embodiments, a UE may continue running drx-onDurationTimer while stopping monitoring the corresponding PDCCH during LP-WUS monitoring, and may end the Timer set-2 and Timer set-3. This may avoid an issue of too many extensions.

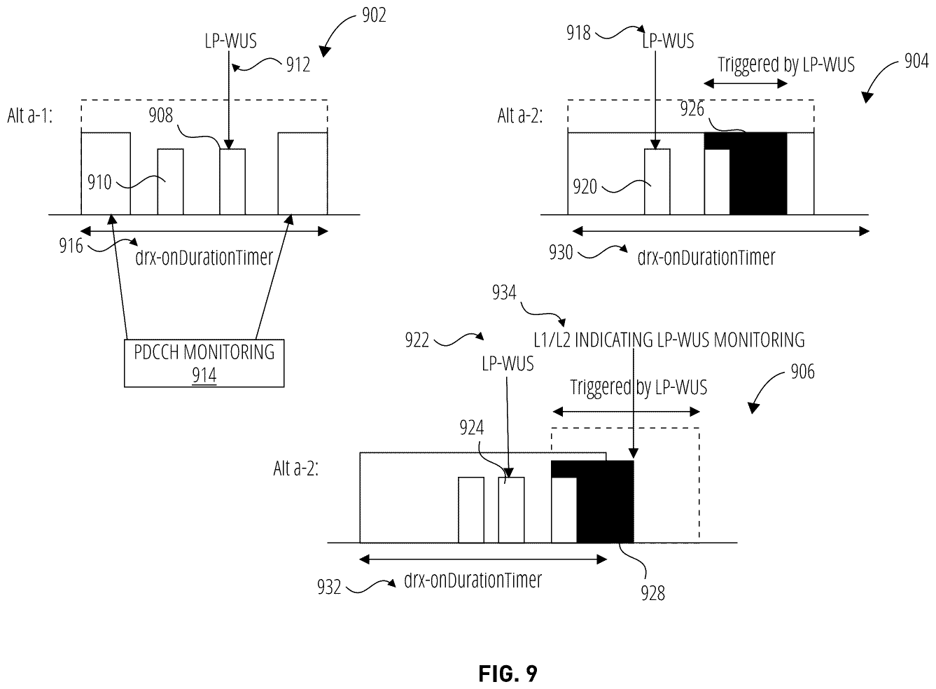

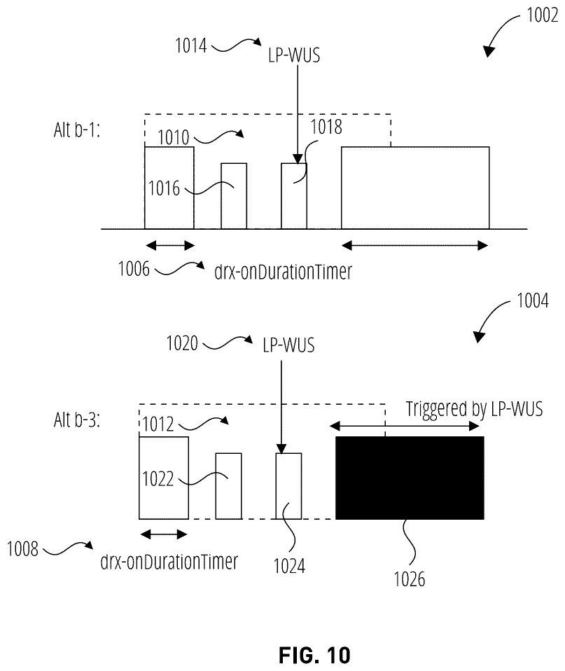

For option 1-3, upon detection of LP-WUS indicating PDCCH monitoring, the behaviors described with reference to FIG. 9 and FIG. 10 could be considered. The behaviors described with reference to FIG. 9 may correspond with embodiments that employ alternate A drx-onDurationTimer behavior described with reference to FIG. 8A (e.g., drx-onDurationTimer continues running, when LP-WUS monitoring is activated). The behaviors described with reference to FIG. 10 may correspond with embodiments that employ alternate B drx-onDurationTimer behavior described with reference to FIG. 8B (e.g., drx-onDurationTimerstops running, when LP-WUS monitoring is activated).

FIG. 9 illustrates three example signaling timelines (e.g., first signaling timeline 902, second signaling timeline 904, and third signaling timeline 906) that show possible UE behaviors upon detection of LP-WUS indicating PDCCH monitoring in embodiments where the Drx-onDurationTimer continues running when LP-WUS monitoring is activated in accordance with some embodiments. The first signaling timeline 902 illustrates an embodiment where upon detection of an LP-WUS 908 in an LP-WUS monitoring occasion (e.g., occasion 910 and occasion 912), the UE starts PDCCH monitoring 914, without any new timers (follow the running drx-onDurationTimer 916).

The second signaling timeline 904 and third signaling timeline 906 illustrate an embodiment where upon detection of an LP-WUS (e.g., LP-WUS 918 and LP-WUS 922) in an LP-WUS monitoring occasion (e.g., LP-WUS monitoring occasion 920 and LP-WUS monitoring occasion 924), the UE starts the drx-InactivityTimer or a new timer (e.g. lp-triggeredTimer) (e.g., timer 926 and timer 928).

The second signaling timeline 904 illustrates a circumstance when the drx-InactivityTimer or lp-triggeredTimer expires (e.g., timer 926), but the drx-onDurationTimer 930 does not. In some embodiments, when the when the drx-InactivityTimer/lp-triggeredTimer expires but the drx-onDurationTimer does not, the UE returns to a LP-WUS monitoring state. The duration of drx-InactivityTimer/lp-triggeredTimer triggered by LP-WUS could be equal to pdcch-NoDetectDuration (if configured).

The second signaling timeline 904 illustrates a circumstance when the drx-InactivityTimer or lp-triggeredTimer (e.g., timer 928) is running, but the drx-onDurationTimer 932 expires. In some embodiments, when the timer 928 is running when the drx-onDurationTimer 932 expires the UE keeps monitoring PDCCH. Further, in some embodiments that start a timer upon LP-WUS detection, the legacy behaviors of other timers may be maintained (e.g., retransmission timer, etc.).

In some embodiments, L1-L2 signaling may be used to terminate the InactivityTimer or lp-triggeredTimer (e.g., timer 926 and timer 928). For example, when drx-onDurationTimer 932 is expired within the time when drx-InactivityTimer/lp-triggeredTime/other legacy timers included in Active Time are still running (e.g., 928), if the UE receives the L1/L2 signaling 934 indicating the start of LP-WUS monitoring, the UE may terminate these timers and stop PDCCH monitoring.

FIG. 10 illustrates two example signaling timelines (e.g., first signaling timeline 1002 and second signaling timeline 1004) that show possible UE behaviors upon detection of LP-WUS indicating PDCCH monitoring in embodiments where the drx-onDurationTimer (e.g., drx-onDurationTimer 1006 and drx-onDurationTimer 1008) stops running when LP-WUS monitoring is activated (e.g., LP-WUS monitoring period 1010 and LP-WUS monitoring period 1012) in accordance with some embodiments. The first signaling timeline 1002 illustrates an embodiment where upon detection of an LP-WUS 1014 in an LP-WUS monitoring occasion (e.g., occasion 1016 and occasion 1018), the UE may resume the drx-onDurationTimer 1006, until the total length of the timer is met.

In some embodiments, upon detection of an LP-WUS in an LP-WUS monitoring occasion, the UE may resume the drx-onDurationTimer and start a drx-inactivityTimer or new timer. In some embodiments, the drx-onDurationTimer will also be stopped after receiving the LP-WUS monitoring indication, starting two timers for the same purpose may be redundant.

The second signaling timeline 1004 illustrates an embodiment where upon detection of an LP-WUS 1020 in an LP-WUS monitoring occasion (e.g., occasion 1022 and occasion 1024), the UE may only start the drx-inactivityTimer/new timer (e.g., timer 1026). In such embodiments, drx-onDurationTimer 1008 is only started at the beginning of each cycle, and the ending time is determined by the earlier of when LP-WUS monitoring is first activated and the duration of the drx-onDurationTimer.

In some embodiments, UE behaviors discussed with reference to FIGS. 6-10 (Option 1-3) may be combined with the options previously discussed (e.g., Option 1-1, Option 1-2-1, Option 1-2-2). In some embodiments, if Option 1-3 is combined only with Option 1-1, the legacy drx-onDurationTimer may be triggered based on detection of LP-WUS, and UE behaviors may follow Option 1-1. Further, if Option 1-3 is combined only with Option 1-1, when legacy drx-onDurationTimer is triggered, the UE may follow the behaviors under Option 1-3.

In some embodiments, Option 1-3 may be combined with Option 1-2-1. If Option 1-3 is combined with Option 1-2-1, the legacy drx-onDurationTimer may be triggered based on detection of LP-WUS (legacy C-DRX Active Time). A new timer or drx-inactivityTimer can be also triggered by the detection of LP-WUS. The triggering of PDCCH follow Option 1-2-1, then whether Option 1-3 will be applied inside the new timers could be further determined. In some embodiments, the new timer/drx-inactivityTimer may be included in the New C-DRX Active Time. For example, the UE may monitor LP-WUS in both legacy C-DRX Active Time and New C-DRX Active Time, then the behaviors under Option 1-3 previously discussed may be followed. In some embodiments, new timer/drx-inactivityTimer may be included in the New C-DRX Active Time, however the UE may not monitor LP-WUS in this new C-DRX Active Time considering that the timer triggered by LP-WUS may be relatively small compared to legacy drx-onDurationTimer or drx-inactivityTimer (there is no need to switch to LP-WUS again during this time). This may conserve power by using the shorter timer and not switching monitoring behaviors frequently.

In some embodiments, Option 1-3 may be combined with Option 1-2-2. If Option 1-3 is combined with Option 1-2-2, the legacy drx-onDurationTimer may not be triggered. The legacy drx-inactivityTimer may be triggered based on the transmission (e.g., Legacy C-DRX Active Time). A new timer/drx-inactivityTimer may be triggered by the detection of LP-WUS (e.g., New C-DRX Active Time). Whether Option 1-3 will be applied inside the new C-DRX Active Time could be up to implementation. In some embodiments, the behaviors under Option 1-3 previously described may be applied to both legacy C-DRX Active Time and New C-DRX Active Time. In some embodiments, the behaviors under Option 1-3 may be applied only to legacy C-DRX Active Time, but not applied to new C-DRX Active Time.

Measurement behavior enhancements may be introduced for different measurement types. In some embodiments, CSI measurement and reporting may be performed during the PDCCH monitoring duration triggered by LP-WUS. In some embodiments, both the legacy Active Time and the new Active Time should be considered for CSI measurement and reporting. In some embodiments, a network node may configure whether the UE needs to report CSI during the drx-onDurationTimer that is outside Active Time.

For performing RRM measurements, some embodiments may employ the following enhancements. In some embodiments, there may be no change to the existing RRM measurement, where the UE may not expect the CSI-RS available outside Active Time (including both legacy and new Active Time) and the drx-onDurationTimer Active Time, when C-DRX cycle is larger than a threshold. In some embodiments, RRM measurement may be further relaxed to multiples of C-DRX cycle. For example, the UE may expect that CSI-RS for L3 mobility may be available according to a scaling factor N of C-DRX cycles, and the UE may expect that CSI-RS for L3 mobility is available in the Active Time. This may further reduce power use by the UE, for example considering that in Option 1-2-2 the drx-onDurationTimer may not be triggered and the relaxation could further reduce UE power.

To perform the RLM/BFD measurement, the UE may employ the following options. In some embodiments, there may be no change to the existing measurement requirement. In some embodiments, the RLM/BFD measurement may be relaxed to multiples of C-DRX cycles.

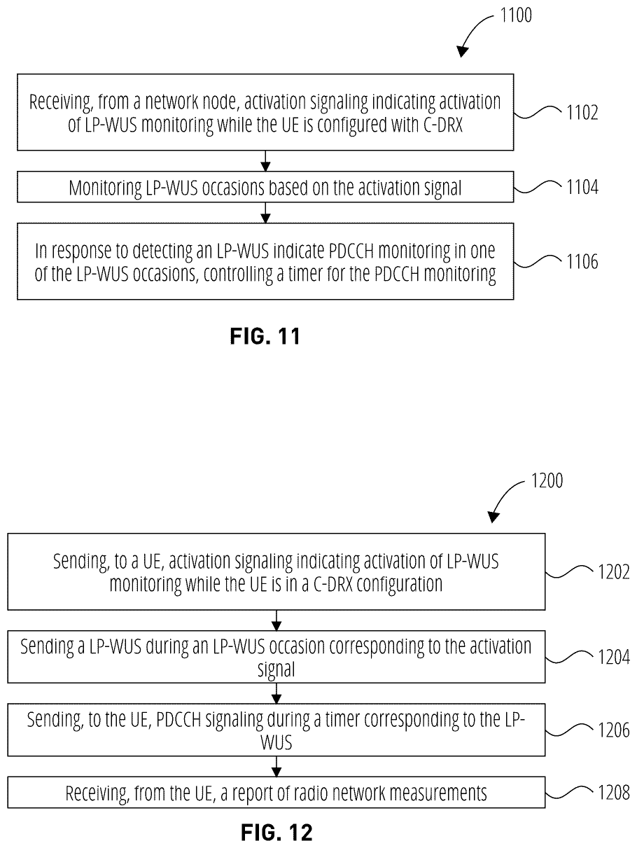

FIG. 11 illustrates a method 1100 performed by a UE, according to embodiments herein. The illustrated method 1100 includes receiving 1102, from a network node, activation signaling indicating activation of LP-WUS monitoring while the UE is configured with C-DRX. The method 1100 further includes monitoring 1104 LP-WUS occasions based on the activation signal. The method 1100 further includes, in response to detecting an LP-WUS indicates PDCCH monitoring in one of the LP-WUS occasions, controlling 1106 a timer for the PDCCH monitoring.

In some embodiments, the method 1100 further comprises performing radio network measurements based on the timer for the PDCCH monitoring, and sending, to the network node, a report of the radio network measurements.

In some embodiments of the method 1100, the activation signaling comprises an RRC configuration, and wherein monitoring LP-WUS is based on the RRC configuration. In some such embodiments, the RRC configuration comprises a first LP-WUS configuration corresponding to a legacy drx-onDurationTimer, and a second first LP-WUS configuration corresponding to a new timer or drx-InactivityTimer. In some other such embodiments, the RRC configuration comprises a LP-WUS configuration that includes a window, wherein in response to detecting the LP-WUS inside the window, the timer that is initiated is a drx-onDurationTimer, and wherein in response to detecting the LP-WUS outside the window, the timer that is initiated is a new timer or drx-InactivityTimer. Yet some other such embodiments further comprise receiving, from the network node, an indication of which timer type the LP-WUS triggers. In yet some other such embodiments, the RRC configuration provides one LP-WUS configuration that indicates LP-WUS monitoring behavior outside C-DRX Active Time.

In some embodiments of the method 1100, the activation signaling comprises L1 or L2 signaling indicates a start of LP-WUS monitoring inside of C-DRX Active Time.

In some embodiments of the method 1100, the activation signaling comprises a parameter that specifies a duration for which the UE should continuously fail to detect the PDCCH inside of C-DRX Active Time before LP-WUS monitoring is activated.

In some embodiments of the method 1100, the activation signaling causes the UE to monitor the LP-WUS occasions in a window before a start of drx-onDurationTimer.

In some embodiments of the method 1100, a PDCCH monitoring duration triggered by the LP-WUS is included in C-DRX Active Time.

In some embodiments of the method 1100, a PDCCH monitoring duration triggered by the LP-WUS is not included in C-DRX Active Time.

13. The method of claim 1, wherein the monitoring of the LP-WUS occasions occurs inside C-DRX Active Time, and a drx-onDurationTimer continues running during the monitoring of the LP-WUS occasions.

In some embodiments of the method 1100, the monitoring of the LP-WUS occasions occurs inside C-DRX Active Time, and a drx-onDurationTimer stops running during the monitoring of the LP-WUS occasions and begins again when the LP-WUS is detected.

In some embodiments of the method 1100, the timer comprises a drx-onDurationTimer, a drx-InactivityTimer, or a timer type corresponding to the LP-WUS (lp-triggeredTimer).

FIG. 12 illustrates a method 1200 performed by a network node, according to embodiments herein. The illustrated method 1200 includes sending 1202, to a UE, activation signaling indicating activation of LP-WUS monitoring while the UE is in a C-DRX configuration. The method 1200 further includes sending 1204 a LP-WUS during an LP-WUS occasion corresponding to the activation signal. The method 1200 further includes sending 1206, to the UE, PDCCH signaling during a timer corresponding to the LP-WUS. The method 1200 further includes receiving 1208, from the UE, a report of radio network measurements.

In some embodiments of the method 1200, the activation signaling comprises an RRC configuration, and wherein monitoring LP-WUS is based on the RRC configuration. In some such embodiments, the RRC configuration comprises a first LP-WUS configuration corresponding to a legacy drx-onDurationTimer, and a second first LP-WUS configuration corresponding to a new timer or drx-InactivityTimer. In some other such embodiments, the RRC configuration comprises a LP-WUS configuration that includes a window, wherein sending the LP-WUS inside the window causes the UE is to initiate a drx-onDurationTimer, and wherein sending the LP-WUS outside the window causes the UE is to initiate a new timer or drx-InactivityTimer. Yet some other such embodiments further comprise sending, to the UE, an indication of which timer type the LP-WUS triggers. In yet some other such embodiments, the RRC configuration provides one LP-WUS configuration that indicates LP-WUS monitoring behavior outside C-DRX Active Time.

In some embodiments of the method 1200, the activation signaling comprises L1 or L2 signaling indicates a start of LP-WUS monitoring inside of C-DRX Active Time.

In some embodiments of the method 1200, the activation signaling comprises a parameter that specifies a duration for which the UE should continuously fail to detect the PDCCH inside of C-DRX Active Time before LP-WUS monitoring is activated.

In some embodiments of the method 1200, the activation signaling causes the UE to monitor the LP-WUS occasions in a window before a start of drx-onDurationTimer.

In some embodiments of the method 1200, a PDCCH monitoring duration triggered by the LP-WUS is included in C-DRX Active Time.

In some embodiments of the method 1200, a PDCCH monitoring duration triggered by the LP-WUS is not included in C-DRX Active Time.

In some embodiments of the method 1200, the monitoring of the LP-WUS occasions occurs inside C-DRX Active Time, and a drx-onDurationTimer continues running during the monitoring of the LP-WUS occasions.

In some embodiments of the method 1200, the monitoring of the LP-WUS occasions occurs inside C-DRX Active Time, and a drx-onDurationTimer stops running during the monitoring of the LP-WUS occasions and begins again when the LP-WUS is detected.

In some embodiments of the method 1200, the timer comprises a drx-onDurationTimer, a drx-InactivityTimer, or a timer type corresponding to the LP-WUS (lp-triggeredTimer).

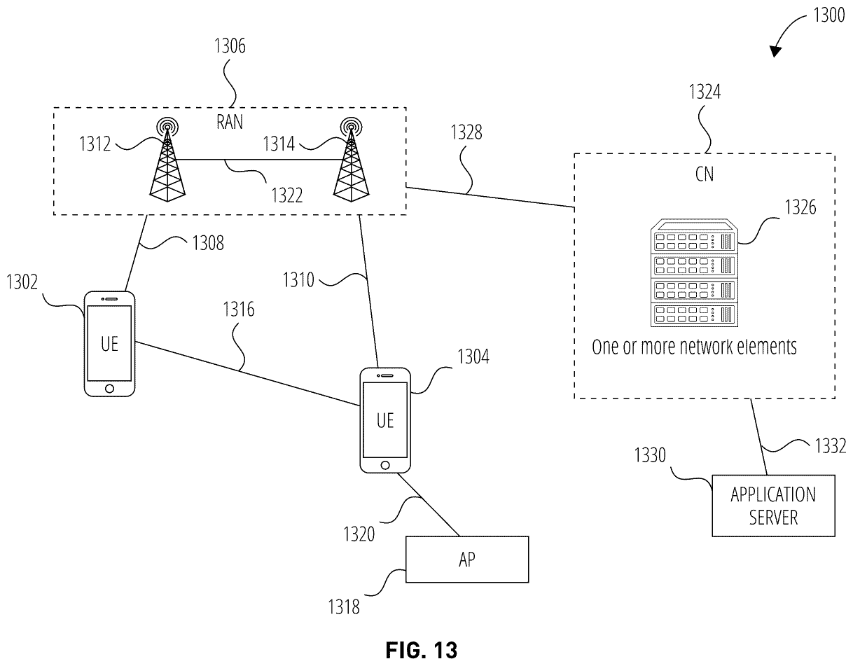

FIG. 13 illustrates an example architecture of a wireless communication system 1300, according to embodiments disclosed herein. The following description is provided for an example wireless communication system 1300 that operates in conjunction with the LTE system standards and/or 5G or NR system standards as provided by 3GPP technical specifications.

As shown by FIG. 13, the wireless communication system 1300 includes UE 1302 and UE 1304 (although any number of UEs may be used). In this example, the UE 1302 and the UE 1304 are illustrated as smartphones (e.g., handheld touchscreen mobile computing devices connectable to one or more cellular networks), but may also comprise any mobile or non-mobile computing device configured for wireless communication.

The UE 1302 and UE 1304 may be configured to communicatively couple with a RAN 1306. In embodiments, the RAN 1306 may be NG-RAN, E-UTRAN, etc. The UE 1302 and UE 1304 utilize connections (or channels) (shown as connection 1308 and connection 1310, respectively) with the RAN 1306, each of which comprises a physical communications interface. The RAN 1306 can include one or more base stations (such as base station 1312 and base station 1314) that enable the connection 1308 and connection 1310.

In this example, the connection 1308 and connection 1310 are air interfaces to enable such communicative coupling, and may be consistent with RAT(s) used by the RAN 1306, such as, for example, an LTE and/or NR.

In some embodiments, the UE 1302 and UE 1304 may also directly exchange communication data via a sidelink interface 1316. The UE 1304 is shown to be configured to access an access point (shown as AP 1318) via connection 1320. By way of example, the connection 1320 can comprise a local wireless connection, such as a connection consistent with any IEEE 802.11 protocol, wherein the AP 1318 may comprise a Wi-Fi® router. In this example, the AP 1318 may be connected to another network (for example, the Internet) without going through a CN 1324.

In embodiments, the UE 1302 and UE 1304 can be configured to communicate using orthogonal frequency division multiplexing (OFDM) communication signals with each other or with the base station 1312 and/or the base station 1314 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1312 or base station 1314 may be implemented as one or more software entities running on server computers as part of a virtual network. In addition, or in other embodiments, the base station 1312 or base station 1314 may be configured to communicate with one another via interface 1322. In embodiments where the wireless communication system 1300 is an LTE system (e.g., when the CN 1324 is an EPC), the interface 1322 may be an X2 interface. The X2 interface may be defined between two or more base stations (e.g., two or more eNBs and the like) that connect to an EPC, and/or between two eNBs connecting to the EPC. In embodiments where the wireless communication system 1300 is an NR system (e.g., when CN 1324 is a 5GC), the interface 1322 may be an Xn interface. The Xn interface is defined between two or more base stations (e.g., two or more gNBs and the like) that connect to 5GC, between a base station 1312 (e.g., a gNB) connecting to 5GC and an eNB, and/or between two eNBs connecting to 5GC (e.g., CN 1324).

The RAN 1306 is shown to be communicatively coupled to the CN 1324. The CN 1324 may comprise one or more network elements 1326, which are configured to offer various data and telecommunications services to customers/subscribers (e.g., users of UE 1302 and UE 1304) who are connected to the CN 1324 via the RAN 1306. The components of the CN 1324 may be implemented in one physical device or separate physical devices including components to read and execute instructions from a machine-readable or computer-readable medium (e.g., a non-transitory machine-readable storage medium).

In embodiments, the CN 1324 may be an EPC, and the RAN 1306 may be connected with the CN 1324 via an S1 interface 1328. In embodiments, the S1 interface 1328 may be split into two parts, an S1 user plane (S1-U) interface, which carries traffic data between the base station 1312 or base station 1314 and a serving gateway (S-GW), and the S1-MME interface, which is a signaling interface between the base station 1312 or base station 1314 and mobility management entities (MMEs).

In embodiments, the CN 1324 may be a 5GC, and the RAN 1306 may be connected with the CN 1324 via an NG interface 1328. In embodiments, the NG interface 1328 may be split into two parts, an NG user plane (NG-U) interface, which carries traffic data between the base station 1312 or base station 1314 and a user plane function (UPF), and the S1 control plane (NG-C) interface, which is a signaling interface between the base station 1312 or base station 1314 and access and mobility management functions (AMFs).

Generally, an application server 1330 may be an element offering applications that use internet protocol (IP) bearer resources with the CN 1324 (e.g., packet switched data services). The application server 1330 can also be configured to support one or more communication services (e.g., VoIP sessions, group communication sessions, etc.) for the UE 1302 and UE 1304 via the CN 1324. The application server 1330 may communicate with the CN 1324 through an IP communications interface 1332.

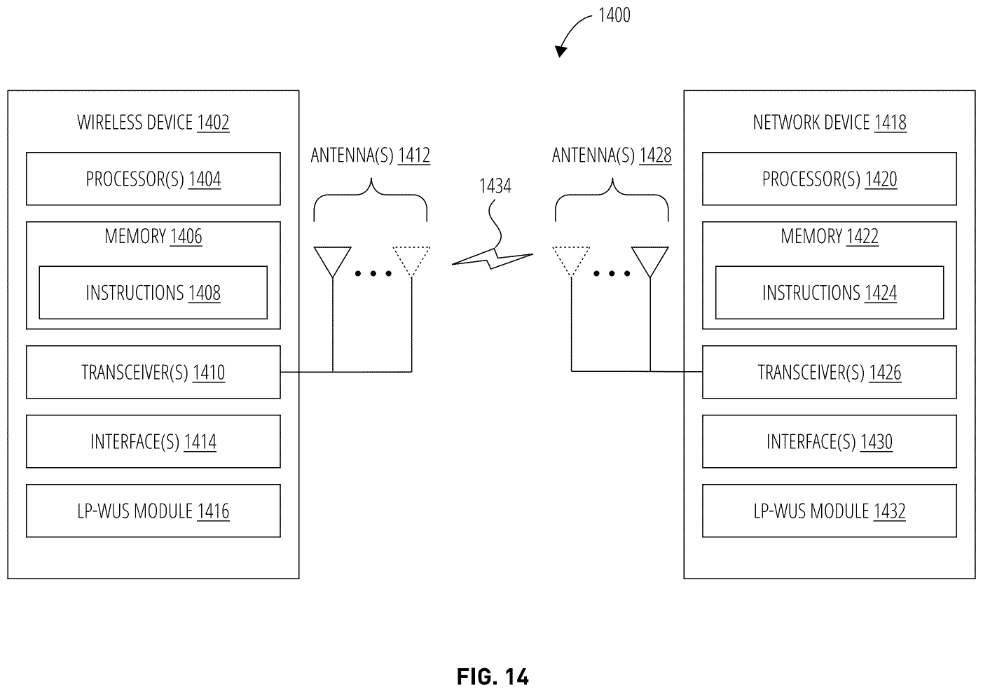

FIG. 14 illustrates a system 1400 for performing signaling 1434 between a wireless device 1402 and a network device 1418, according to embodiments disclosed herein. The system 1400 may be a portion of a wireless communications system as herein described. The wireless device 1402 may be, for example, a UE of a wireless communication system. The network device 1418 may be, for example, a base station (e.g., an eNB or a gNB) of a wireless communication system.

The wireless device 1402 may include one or more processor(s) 1404. The processor(s) 1404 may execute instructions such that various operations of the wireless device 1402 are performed, as described herein. The processor(s) 1404 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1402 may include a memory 1406. The memory 1406 may be a non-transitory computer-readable storage medium that stores instructions 1408 (which may include, for example, the instructions being executed by the processor(s) 1404). The instructions 1408 may also be referred to as program code or a computer program. The memory 1406 may also store data used by, and results computed by, the processor(s) 1404.

The wireless device 1402 may include one or more transceiver(s) 1410 that may include radio frequency (RF) transmitter circuitry and/or receiver circuitry that use the antenna(s) 1412 of the wireless device 1402 to facilitate signaling (e.g., the signaling 1434) to and/or from the wireless device 1402 with other devices (e.g., the network device 1418) according to corresponding RATs.

The wireless device 1402 may include one or more antenna(s) 1412 (e.g., one, two, four, or more). For embodiments with multiple antenna(s) 1412, the wireless device 1402 may leverage the spatial diversity of such multiple antenna(s) 1412 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1402 may be accomplished according to precoding (or digital beamforming) that is applied at the wireless device 1402 that multiplexes the data streams across the antenna(s) 1412 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1402 may implement analog beamforming techniques, whereby phases of the signals sent by the antenna(s) 1412 are relatively adjusted such that the (joint) transmission of the antenna(s) 1412 can be directed (this is sometimes referred to as beam steering).

The wireless device 1402 may include one or more interface(s) 1414. The interface(s) 1414 may be used to provide input to or output from the wireless device 1402. For example, a wireless device 1402 that is a UE may include interface(s) 1414 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1410/antenna(s) 1412 already described) that allow for communication between the UE and other devices and may operate according to known protocols (e.g., Wi-Fi®, Bluetooth®, and the like).

The wireless device 1402 may include an LP-WUS module 1416. The LP-WUS module 1416 may be implemented via hardware, software, or combinations thereof. For example, the LP-WUS module 1416 may be implemented as a processor, circuit, and/or instructions 1408 stored in the memory 1406 and executed by the processor(s) 1404. In some examples, the LP-WUS module 1416 may be integrated within the processor(s) 1404 and/or the transceiver(s) 1410. For example, the LP-WUS module 1416 may be implemented by a combination of software components (e.g., executed by a DSP or a general processor) and hardware components (e.g., logic gates and circuitry) within the processor(s) 1404 or the transceiver(s) 1410.

The LP-WUS module 1416 may be used for various aspects of the present disclosure, for example, aspects of FIGS. 1-11.

The network device 1418 may include one or more processor(s) 1420. The processor(s) 1420 may execute instructions such that various operations of the network device 1418 are performed, as described herein. The processor(s) 1420 may include one or more baseband processors implemented using, for example, a CPU, a DSP, an ASIC, a controller, an FPGA device, another hardware device, a firmware device, or any combination thereof configured to perform the operations described herein.

The network device 1418 may include a memory 1422. The memory 1422 may be a non-transitory computer-readable storage medium that stores instructions 1424 (which may include, for example, the instructions being executed by the processor(s) 1420). The instructions 1424 may also be referred to as program code or a computer program. The memory 1422 may also store data used by, and results computed by, the processor(s) 1420.

The network device 1418 may include one or more transceiver(s) 1426 that may include RF transmitter circuitry and/or receiver circuitry that use the antenna(s) 1428 of the network device 1418 to facilitate signaling (e.g., the signaling 1434) to and/or from the network device 1418 with other devices (e.g., the wireless device 1402) according to corresponding RATs.

The network device 1418 may include one or more antenna(s) 1428 (e.g., one, two, four, or more). In embodiments having multiple antenna(s) 1428, the network device 1418 may perform MIMO, digital beamforming, analog beamforming, beam steering, etc., as has been described.

The network device 1418 may include one or more interface(s) 1430. The interface(s) 1430 may be used to provide input to or output from the network device 1418. For example, a network device 1418 that is a base station may include interface(s) 1430 made up of transmitters, receivers, and other circuitry (e.g., other than the transceiver(s) 1426/antenna(s) 1428 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1418 may include an LP-WUS module 1432. The LP-WUS module 1432 may be implemented via hardware, software, or combinations thereof. For example, the LP-WUS module 1432 may be implemented as a processor, circuit, and/or instructions 1424 stored in the memory 1422 and executed by the processor(s) 1420. In some examples, the LP-WUS module 1432 may be integrated within the processor(s) 1420 and/or the transceiver(s) 1426. For example, the LP-WUS module 1432 may be implemented by a combination of software components (e.g., executed by a DSP or a general processor) and hardware components (e.g., logic gates and circuitry) within the processor(s) 1420 or the transceiver(s) 1426.

The LP-WUS module 1432 may be used for various aspects of the present disclosure, for example, aspects of FIGS. 1-11.

Embodiments contemplated herein include an apparatus comprising means to perform one or more elements of the method 1100. This apparatus may be, for example, an apparatus of a UE (such as a wireless device 1402 that is a UE, as described herein).

Embodiments contemplated herein include one or more non-transitory computer-readable media comprising instructions to cause an electronic device, upon execution of the instructions by one or more processors of the electronic device, to perform one or more elements of the method 1100. This non-transitory computer-readable media may be, for example, a memory of a UE (such as a memory 1406 of a wireless device 1402 that is a UE, as described herein).

Embodiments contemplated herein include an apparatus comprising logic, modules, or circuitry to perform one or more elements of the method 1100. This apparatus may be, for example, an apparatus of a UE (such as a wireless device 1402 that is a UE, as described herein).

Embodiments contemplated herein include an apparatus comprising: one or more processors and one or more computer-readable media comprising instructions that, when executed by the one or more processors, cause the one or more processors to perform one or more elements of the method 1100. This apparatus may be, for example, an apparatus of a UE (such as a wireless device 1402 that is a UE, as described herein).

Embodiments contemplated herein include a signal as described in or related to one or more elements of the method 1100.

Embodiments contemplated herein include a computer program or computer program product comprising instructions, wherein execution of the program by a processor is to cause the processor to carry out one or more elements of the method 1100. The processor may be a processor of a UE (such as a processor(s) 1404 of a wireless device 1402 that is a UE, as described herein). These instructions may be, for example, located in the processor and/or on a memory of the UE (such as a memory 1406 of a wireless device 1402 that is a UE, as described herein).

Embodiments contemplated herein include an apparatus comprising means to perform one or more elements of the method 1200. This apparatus may be, for example, an apparatus of a base station (such as a network device 1418 that is a base station, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a base station (such as a memory 1422 of a network device 1418 that is a base station, as described herein).

Embodiments contemplated herein include an apparatus comprising logic, modules, or circuitry to perform one or more elements of the method 1200. This apparatus may be, for example, an apparatus of a base station (such as a network device 1418 that is a base station, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a base station (such as a network device 1418 that is a base station, as described herein).

Embodiments contemplated herein include a signal as described in or related to one or more elements of the method 1200.

Embodiments contemplated herein include a computer program or computer program product comprising instructions, wherein execution of the program by a processing element is to cause the processing element to carry out one or more elements of the method 1200. The processor may be a processor of a base station (such as a processor(s) 1420 of a network device 1418 that is a base station, as described herein).

These instructions may be, for example, located in the processor and/or on a memory of the base station (such as a memory 1422 of a network device 1418 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a User Equipment (UE), the method comprising:
receiving, from a network node, activation signaling indicating activation of Low Power Wake-Up Signal (LP-WUS) monitoring while the UE is configured with Connected-mode Discontinuous Reception (C-DRX);
monitoring LP-WUS occasions based on the activation signal; and
in response to detecting an LP-WUS indicating Physical Downlink Control Channel (PDCCH) monitoring in one of the LP-WUS occasions, controlling a timer for the PDCCH monitoring.

2. The method of claim 1, further comprising:
performing radio network measurements based on the timer for the PDCCH monitoring; and
sending, to the network node, a report of the radio network measurements.

3. The method of claim 1, wherein the activation signaling comprises a Radio Resource Control (RRC) configuration, and wherein monitoring LP-WUS is based on the RRC configuration.

4. The method of claim 3, wherein the RRC configuration comprises a first LP-WUS configuration corresponding to a legacy drx-onDurationTimer, and a second first LP-WUS configuration corresponding to a new timer or drx-InactivityTimer.

5. The method of claim 3, wherein the RRC configuration comprises a LP-WUS configuration that includes a window,
wherein in response to detecting the LP-WUS inside the window, the timer that is initiated is a drx-onDurationTimer, and
wherein in response to detecting the LP-WUS outside the window, the timer that is initiated is a new timer or drx-InactivityTimer.

6. The method of claim 3, further comprising receiving, from the network node, an indication of which timer type the LP-WUS triggers.

7. The method of claim 3, wherein the RRC configuration provides one LP-WUS configuration that indicates LP-WUS monitoring behavior outside C-DRX Active Time.

8. The method of claim 1, wherein the activation signaling comprises Layer 1 (L1) or Layer 2 (L2) signaling indicates a start of LP-WUS monitoring inside of C-DRX Active Time.

9. The method of claim 1, wherein the activation signaling comprises a parameter that specifies a duration for which the UE should continuously fail to detect the PDCCH inside of C-DRX Active Time before LP-WUS monitoring is activated.

10. The method of claim 1, wherein the activation signaling causes the UE to monitor the LP-WUS occasions in a window before a start of drx-onDurationTimer.

11. The method of claim 1, wherein a PDCCH monitoring duration triggered by the LP-WUS is included in C-DRX Active Time.

12. The method of claim 1, wherein a PDCCH monitoring duration triggered by the LP-WUS is not included in C-DRX Active Time.

13. The method of claim 1, wherein the monitoring of the LP-WUS occasions occurs inside C-DRX Active Time, and a drx-onDurationTimer continues running during the monitoring of the LP-WUS occasions.

14. The method of claim 1, wherein the monitoring of the LP-WUS occasions occurs inside C-DRX Active Time, and a drx-onDurationTimer stops running during the monitoring of the LP-WUS occasions and begins again when the LP-WUS is detected.

15. The method of claim 1, wherein the timer comprises a drx-onDurationTimer, a drx-InactivityTimer, or a timer type corresponding to the LP-WUS (lp-triggeredTimer).

16. A method performed by a network node, the method comprising:
sending, to a User Equipment (UE), activation signaling indicating activation of Low Power Wake-Up Signal (LP-WUS) monitoring while the UE is in a Connected-mode Discontinuous Reception (C-DRX) configuration;
sending a LP-WUS during an LP-WUS occasion corresponding to the activation signal;
sending, to the UE, Physical Downlink Control Channel (PDCCH) signaling during a timer corresponding to the LP-WUS; and
receiving, from the UE, a report of radio network measurements.

17. The method of claim 16, wherein the activation signaling comprises a Radio Resource Control (RRC) configuration, and wherein monitoring LP-WUS is based on the RRC configuration.

18. The method of claim 17, wherein the RRC configuration comprises a first LP-WUS configuration corresponding to a legacy drx-onDurationTimer, and a second first LP-WUS configuration corresponding to a new timer or drx-InactivityTimer.

19. The method of claim 17, wherein the RRC configuration comprises a LP-WUS configuration that includes a window,
wherein sending the LP-WUS inside the window causes the UE is to initiate a drx-onDurationTimer, and
wherein sending the LP-WUS outside the window causes the UE is to initiate a new timer or drx-InactivityTimer.

20. The method of claim 17, further comprising sending, to the UE, an indication of which timer type the LP-WUS triggers.
